(19) United States
(12) Patent Application Publication
(10) Pub. No.: US 2010/0250367 A1
(43) Pub. Date: Sep. 30, 2010

(54) RELEVANCY OF VIRTUAL MARKERS

(75) Inventors: Leonard Smith, Seattle, WA (US); Gur Kimchi, Bellevue, WA (US); Avi Bar-Zeev, Redmond, WA (US); Blaise H. Aguera y Arcas, Seattle, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/415,946

(22) Filed: Mar. 31, 2009

(51) Int. Cl. G01C 21/00; G06Q 30/00; G06F 17/30

(52) U.S. Cl. 705/14.58; 701/200

(57) ABSTRACT

Aspects relate to providing markers related to a mapping application, wherein the provided markers are selectively modified as a function of the relevancy of the markers to a person that has requested the markers. The relevancy is determined based on one or more indicators included in the marker. The indicators answer questions related to who, what, when, where, and why. Markers can be ranked based on the association between the person that requested the marker and the person that provided the marker. Further, a copy of an original marker can be modified to conform with the relevancy of the marker to the requestor.

### BACKGROUND

Numerous computer applications have been built around understanding a user's location and leveraging that location knowledge, often in connection with a stated destination or near-by points of potential interest, since the development and commercial access to Global Positioning System (GPS) and other Global Navigation Satellite Systems (GNSS), as well as various other Location-Based Services (LBS). For example, GPS navigation systems were first utilized in connection with two-dimensional orthographic projection maps to assist users to travel from location to location. GPS (or other LBS systems) have expanded to assist in discovering and delivering general information about a user's current location and can include information about local business listings, advertisements, and so forth.

Given a user's location, conventional devices can provide directions to specific locations and, in some cases, can allow users to discover services or content relevant to the current location. Such services can even be helpful at a street-level scale. However, current systems and methods for understanding the location of a user do not provide the granularity to understand a real context of a user.

Further, many people prefer to communicate with others through various devices (e.g., mobile phone, computer, and so on) instead of (or as a supplement to) conducting face-to-face communications. Since communication devices are readily available, usage of these devices occurs at any time and any place. Thus, there is a vast amount of data accessible to a device as it relates to the device user. However, conventional systems do not exploit this information in a manner that can be of benefit to the user.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with accepting one or more markers and associated indicators, wherein the one or more markers correspond to a similar geographic location or different geographic locations. The locations can be physical locations or virtual locations accessible though interaction with a user device. When a person desires to review various markers associated with a geographic area, a received marker is evaluated for content and can be selectively modified before being presented to the requestor. The modifications can be based on a relevance of the marker to the requestor, which can be determined as a function of preferences, historical information, or other parameters.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates a system for managing markers, according to an aspect.

FIG. 2 illustrates a system for determining relevancy of markers, according to an aspect.

FIG. 3 illustrates a system for gathering information associated with a requestor in order to provide markers that are relevant for the requestor according to one or more aspects.

FIG. 4 illustrates a system for changing one or more markers to a format that is of relevance to a requestor of that marker, according to an aspect.

FIG. 5 illustrates a system that employs machine learning and reasoning to automate one or more features in accordance with the disclosed aspects.

FIG. 6 illustrates a method for receiving markers associated with a mapping application, according to an aspect.

FIG. 7 illustrates a method for selectively rendering markers based upon a request in accordance with an aspect.

FIG. 8 illustrates a block diagram of a computer operable to execute the disclosed architecture.

FIG. 9 illustrates a schematic block diagram of an exemplary computing environment in accordance with the various aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Computing systems employing automated learning and reasoning procedures (e.g., the use of explicitly and/or implicitly trained statistical classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Other inputs can include, for example, cameras, accelerometers, compass, microphone, barometer, force sensor, temperature, blood pressure/heart monitoring, as well as other interfaces. Examples of such devices include computers (desktop and mobile), smart phones, personal digital assistants (PDAs), and other electronic devices both wired and wireless.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

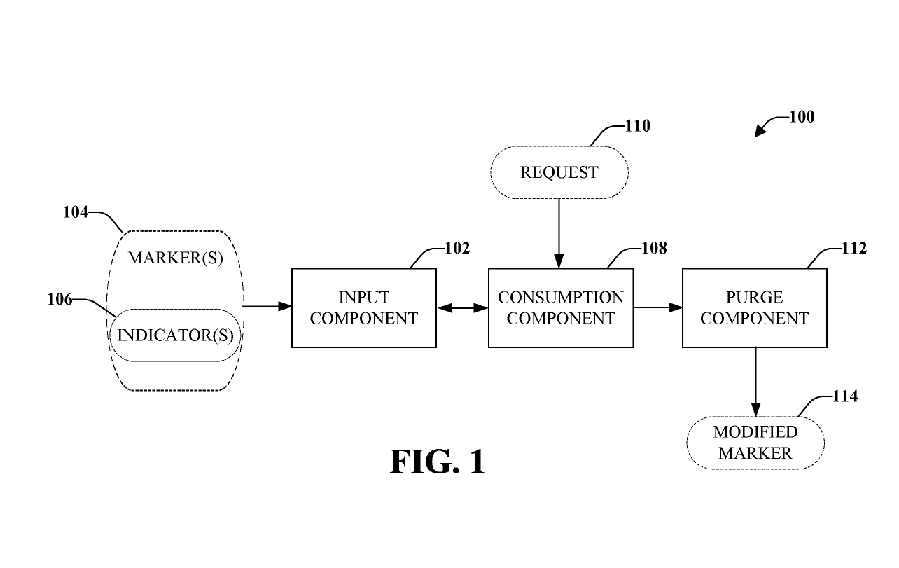

Referring initially to FIG. 1, illustrated is a system 100 for managing markers, according to an aspect. As utilized herein a “marker” can be any information, data, advertisement, photograph, drawing, sensation, fragrance, hyper-link, index to a database, comments, ratings, threaded conversations, and/or other content that can be perceived (e.g., visual, audible, tactile, and so forth). Markers can be personalized markers intended specifically for the user (e.g., a message from a friend) and/or generic markers (e.g., an advertisement intended for persons that are near an advertiser's business and/or for persons virtually navigating near the business). According to some aspects, markers can be conditional such that the marker can be seen only from certain directions, zoom level, specific activity of the user that conforms to a profile of the marker. In accordance with some aspects, markers can be associated with geographic coordinates and/or applied to a mapping application, driving directions, and/or other location based applications. Markers can be associated with calendar events, according to some aspects.

System 100 can be included, at least partially, in a user device (e.g., computer, phone, or other computing device), which can be wired and/or wireless. If mobile, the user device can be carried by the user (e.g., hand, pocket, purse, and so on) or by a vehicle associated with the user (e.g., bicycle, automobile, motorcycle, boat, or through other manners of transportation).

System 100 can be configured to manage markers as a function of a relevancy of the markers. As data related to mapping applications and locations within a mapping application are collected, it can become very difficult to manage all of the available data. For example, a person that has visited a restaurant can provide a restaurant review based on their restaurant experience. This review information can be submitted to a mapping application in the form of a marker (e.g., indicates the location within the map in conjunction with the review). When an individual (which can be the individual that provided the marker or another individual) is deciding whether to visit that restaurant, that individual can review the marker (or multiple markers). Due to the length of time between when the reviewer provided the marker and when the individual reviews the marker, some of the information might be relevant while at least a subset of information might no longer be relevant. System 100 can be configured to automatically provide a simple way for the individual requesting the marker to drill down into the most relevant information. Thus, in order to obtain information associated with a place, the user, through utilization of system 100, no longer has to review each marker and make an individual, manual determination as to the relevance of the marker content, which can be time consuming.

As illustrated, system 100 includes an input component 102 that can be configured to receive a marker 104 and an associated indicator 106. Although illustrated and described as a single marker 104 and associated indicator 106, in accordance with various aspects, there can be a multitude of markers and associated indicators. Further, a marker 104 can have a multitude of associated indicators 106. The associated indictors 106 can include an identification of a creator of the marker 104, an identification of an entity that modified the marker 104, as well as other information related to the creation of the marker 104. In accordance with some aspects, the indicator 106 includes a location with which the marker is associated (e.g., address, geographic coordinates, location name, landmark name, and so forth). Alternatively or additionally, indictor 106 can include a reason why the marker was created and/or comments associated with the marker 104. Further, indicator 106 can include information about the content of the marker 104 (e.g., information about what the marker 104 pertains to). In accordance with some aspects, indictor 106 can include any combination of a user identity, a time stamp, a location, a reason, information related to what the marker pertains, and so forth.

In accordance with some aspects, markers can be automatically generated based on events that affect the user. For example, news streams can be captured automatically by system 100 and filtered based on the user's needs. If appropriate, the news streams can be utilized to generate markers and output the generated markers at an appropriate time. Further, traffic conditions, global events, weather conditions, and so forth, can be utilized to automatically create and output markers for consumption by the user.

Also included in system 100 is a consumption component 108 that receives a request 110 for one or more markers 104 and associated indicator(s) 106. The request 110 can be received automatically based on a user location (either a physical location or a virtual location). For example, various locating techniques can be utilized to determine a user location (e.g., GPS and so forth). Based on the determined location, system 100 can infer that the user might be interested in receiving a marker associated with the user's current position. In another example, a user can be navigating virtually in a mapping application (e.g., a user device is utilized to allow the user to “travel” to various locations while that user is in a different location). In this case, as different geographic areas are navigated virtually, markers associated with one or more of those geographic areas can be presented automatically to the user. In accordance with some aspects, the markers 104 are presented automatically based on prior authentication to receive the marker 104 (e.g., user subscribes to an advertising service that provides coupons, sales, promotions, and other advertisements related to a business). For example, the marker can be an advertisement that is automatically presented when a user location matches the location information associated with the advertisement.

Additionally or alternatively, request 110 can be a manual request, which can include parameters in addition to (or in lieu of) parameters associated with a geographic location. For example, a manual request 110 can include parameters associated with an entity that provided the marker (e.g., only provide markers left by designed persons), based on a date range (e.g., only provide markers dated between March 1 and March 4), or based on other criteria (e.g., content of the marker, type of marker, and so forth).

A purge component 112 is configured to automatically modify the marker 104 as a function of the indicator 106 and the request 110. Purge component 112 outputs a modified marker 114, such as through a user interface. For example, if the indicator 106 includes information that does not comply with parameters associated with the request 110, the marker might not be rendered and/or might be modified before rendering. For example, marker 104 might include a restaurant review and also includes the reason that the person that provided the marker visited the restaurant (e.g., on vacation, on business travel, other restaurants were too busy, and so forth). If the request 110 parameters indicate that the requestor is only interested in the review, the marker 104 can be selectively modified by purge component 112 to remove the portion related to why the provider visited the restaurant since this is undesired information.

Additionally or alternatively, purge component 112 can modify the marker 104 automatically as a function of pre-defined criteria. Such predefined criteria can include a time stamp (e.g., “if older than xx days, do not provide the marker”), a provider (e.g., “do not provide markers submitted by “X”), or other parameters associated with markers. In accordance with some aspects, the marker 104 can be modified by purge component 112 as a function of external factors associated with the marker 104 (e.g., chef at restaurant has left the restaurant and a marker associated with that chef is, thus, no longer relevant). According to some aspects, the original marker 104 is not modified but a copy of the marker 104 is utilized by purge component 122 to generate the modified marker 114. In such a manner, the original marker 104 can be selectively retrieved, if desired.

In accordance with some aspects, purge component 112 can filter markers as a function of learning events (e.g., based on user behavior observed by input component 102 or another system 100 component), based on explicit feedback from the user, and so on. Based on the learning events, at least a subset of markers can be filtered from the received markers. For example, the filtering can cause one or more markers to appear or disappear, depending on the relevancy of the markers.

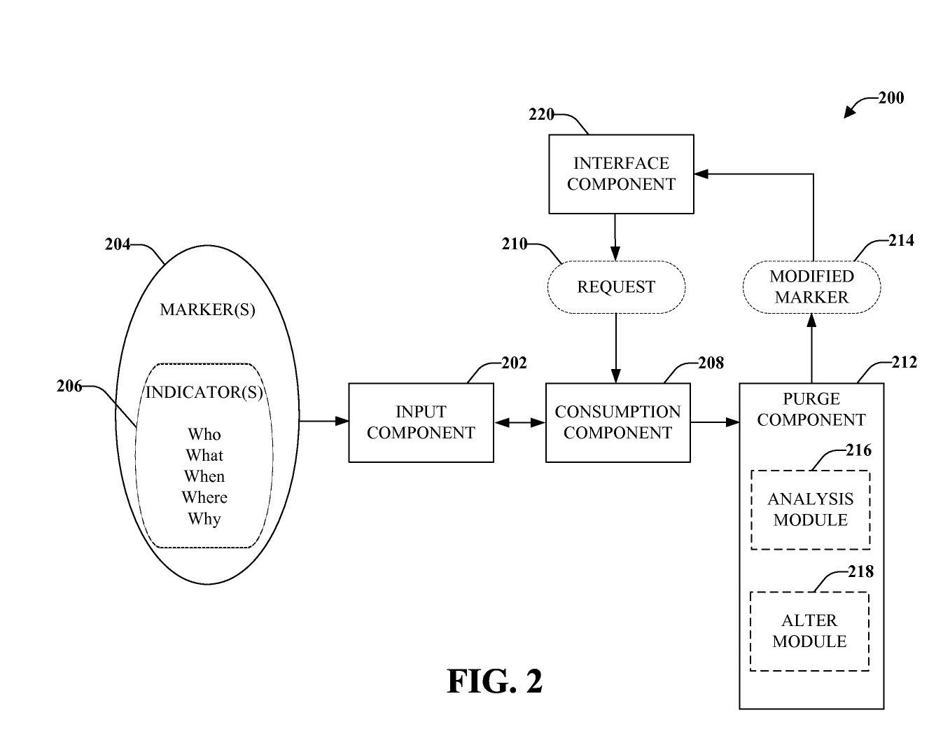

FIG. 2 illustrates a system 200 for determining relevancy of markers, according to an aspect. System 200 includes an input component 202 that accepts one or more markers 204. The markers 204 can be received from a variety of users and/or entities (e.g., the Internet, another system, a computer, and so forth), hereinafter referred to as users. The various markers 204 can include indicators 206 that relate to “Who”, “What”, “When”, “Where”, and “Why” (sometimes referred to as the five “Ws”). Each marker 204 can include all these indicators or a subset thereof. For example, a marker can include “What” the marker relates to (e.g., the service in the restaurant, the food, the chef, the service, and so on). Information related to “Who” can describe the user that provided the marker (e.g., a friend, a stranger, automatically generated, and so forth). The “Why” can define the reason the information was provided (e.g., “I was just at this restaurant and it was excellent and I want to tell everyone”, “I work at this restaurant and want to promote it”, and so on). The “When” information can provide context as to how long ago (in time or based on a different temporal aspect) the marker was provided and/or if there is an expiration associated with the marker (e.g., the marker is only good for a day or a week). The “Where” information can be a geographic location associated with the marker 204. In accordance with some aspects, the “Where” information can be included to determine if the review was provided for the correct location, such as a restaurant. If a virtual location does not match the actual location of the restaurant, it can indicate that the information provider might have reviewed the incorrect restaurant and/or that the marker might contain false or misleading information.

A consumption component 208 can receive a request 210 for one or more markers 204. The request can be a request for markers associated with a geographic location with which the requestor is associated (e.g., physically, virtually). The request 210 can be received automatically, based on an inference that the user would like to be presented with a marker. In accordance with some aspects, the request 210 can be received based on a manual request from a user. The request can be a request for one or more of the five “Ws”, such as for markers provided by a particular person, markers related to a particular location, and so on. The request information can be matched with metadata associated with each marker to make a determination whether there are any markers that comply with the requested information.

One or more markers 204 and associated indicators 206 that correspond to the request 210 are analyzed by a purge component 212. Based on one or more parameters, purge component 212 can transform one or more markers into a modified marker 214, which can be rendered in a perceivable format (e.g., visual, audio, tactile, and so forth). The transformation can include merging two or more markers, deleting one or more markers, modifying at least a portion of a marker, and so forth. The transformation can be performed as a function of one or more indicators 206 and the request 210. In accordance with some aspects, the transformation can be made as a function of indicators of multiple markers and the request 210 (where multiple markers correspond to the request 210).

To perform the transformation, purge component 212 can include an analysis module 216 that is configured to review the indicators 206 and/or content of each marker 204 and determine the relevancy of each marker 204. Determination of the relevancy of each marker 204 can include a review of any or all of the indicators (five “Ws”) as it relates to a particular requestor (e.g., to whom the request 210 belongs and/or to the user that will perceive the modified marker 214). Based on the determination made by analysis module 216, an adjust module 218 can be configured to selectively alter the one or more markers 204 to conform to the request 210 and generate the modified marker 214.

In an example, a person goes into a restaurant and leaves a marker that indicates the restaurant is great (e.g., good service, good food, and so on). The marker, when associated with the restaurant can include all (or a subset of) the five “Ws”, as discussed above. After a certain amount of time (e.g., a week, a month), the marker can become general information that has no relationship with “who” left the information. Thus, over time, certain information associated with the marker might no longer be relevant and, thus, can be removed from the marker before providing the marker in response to the request 210.

In some situations, the marker 204 might become stale and can be automatically deleted by alter component 218 and/or purge component 212. For example, a restaurant review might have been left six months ago and, for purposes of reviewing a restaurant, this information might now be out-of-date, which can be determined based on an expiration associated with the marker and/or policies/rules that relate to a temporal range after which a marker is no longer considered current. In another example, the staleness might be based on external factors (e.g., chef left the restaurant, the menu changed, the restaurant is under new management, and so forth).

The modified markers 214 can be output to the user through an interface component 220, for example. The interface component 220 can provide a graphical user interface (GUI), a command line interface, a speech interface, Natural Language text interface, and the like. For example, a GUI can be rendered that provides a user with a region to load, import, select, read, and so forth, the one or more markers and information contained therein, and can include a region to present the results of such (e.g., request for markers, parameters associated with requested markers, rendering of a modified marker, and so forth). These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed, in accordance with an aspect. For example, the user can interact with interface component 220 by entering information (e.g., accept, deny, modify content) into an edit control.

The user can also interact with the regions to select and provide information through various devices such as a mouse, a roller ball, a keypad, a keyboard, a pen, gestures captured with a camera, motion sensors, and/or voice activation, for example. Typically, a mechanism such as a push button or the enter key on the keyboard can be employed subsequent to entering the information in order to initiate information conveyance. However, it is to be appreciated that the disclosed aspects are not so limited. For example, merely highlighting a check box can initiate information conveyance. In another example, a command line interface can be employed. The command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channel.

Alternatively or additionally, input component 202 can be configured to monitor user activities to allow system 200 to gather learning events. These learning events can be categorized (by analysis module 216 or another system 200 component) by context (e.g., what was the user doing, determination of the purpose of the activity, and so on) and these events can be applied to one or more models that can be maintained, such as in a storage media. The outputs of one or more of the models can be combined with source data (e.g., markers, and so forth) to filter, promote, demote, aggregate, expand, and so on, the various markers. In accordance with some aspects, less relevant markers might still be output in an aggregated form (e.g., “3 restaurants” until at least one of those restaurants becomes more relevant).

In accordance with some aspects, a learning event can be based on a “feedback” button accessible though interaction with interface component 220. The button can be, for example, a rating widget (e.g., “show me more like this”, “show me less like this”) or simply a “close” button that removes unwanted content. According to some aspects, learning events can be based on user explorations (including searches) and an observation of which results are selected, hovered over, or simply viewed (e.g., time a marker spends on a screen is utilized as a potential metric).

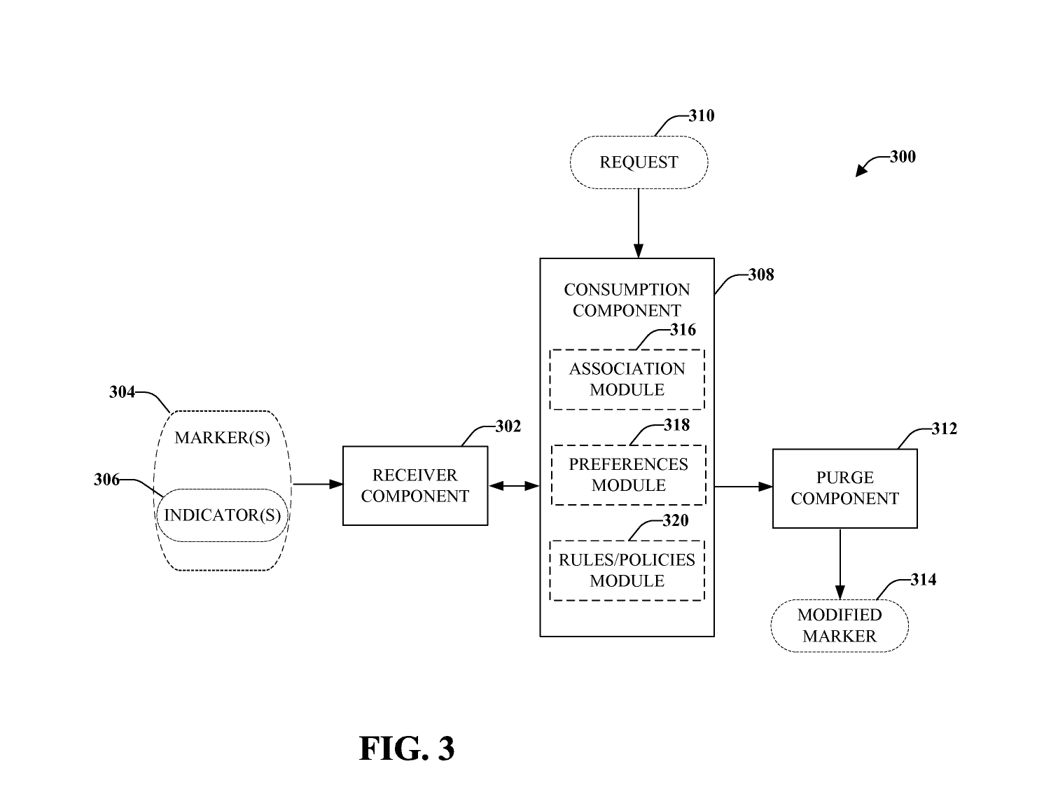

With reference now to FIG. 3, illustrated is a system 300 for gathering information associated with a requestor in order to provide markers that are relevant for the requestor according to one or more aspects. System 300 includes a receiver component 302 that accepts one or more markers 304 and associated indicators 306 (who, what, when, where, why). The markers 304 can be generated automatically or manually by a plurality of users. A consumption component 306 receives a request 310 for one or more markers associated with a geographic location. In accordance with some aspects, there might not be a marker associated with the geographic location and, in accordance with these aspects, a reply to the request 310 can indicate that there are no markers available. If there are markers available, a purge component 312 can selectively alter the markers (if the markers need altering) and output a modified marker 314, which can be presented to a user in any perceivable format. For example, the marker(s) can be output in a display associated with a user device. In another example, the marker(s) can be audibly rendered through speakers associated with a user device.

To determine the relevancy of the markers 304 to the requestor (e.g., the user supplying the request 310), an association module 316 is configured to identify the requestor and the user that provided the marker(s) and determine the relationship between the two. Relationships include a close relationship (e.g., people identified by the requestor, such as in a contact list). The relationships can also provide information that the requestor and the person that supplied the original marker have no connection, and thus the marker can be handled differently than if it was a personal relationship (e.g., the marker can be ignored and a marker associated with a person having a closer relationship with the requestor can be utilized to reply to the request 310).

A preferences module 318 is configured to evaluate preferences of the requestor. The preferences can be explicitly supplied by the requestor, such as through configurable parameters that can be associated with markers, the rendering of markers, and/or other aspects of user device. In accordance with some aspects, preferences module 318 can retain historical information related to the requestor and make an inference based on how the requestor has historically dealt with markers. For example, the requestor might always (or almost all the time) ignore a marker that contains certain content, is provided by a specific user, is older than a certain date (e.g., older than two weeks), and so forth. Based on this historical information, preferences module 318 can infer that a similar action should be performed in association with a current marker and/or request for information.

A rules/policies module 320 can be configured to evaluate rules and/or policies that are configurable manually by the user and/or automatically based on historical information and/or an inference of how markers should be handled. The rules and/or policies can relate to how the requestor would like various markers to be modified and/or rendered. Rules and/or policies can relate to how a particular marker or markers should be handled. For example, a rule can be established that indicates markers entered by a specific user should never be rendered to requestor. In another example, a policy can be established that indicates if the markers are older than one month, the markers should be ignored unless the markers relate to a specific topic and/or were provided by a specific person.

In accordance with some aspects, filtering of various markers might cause the markers to suddenly appear (or disappear after the marker is rendered), which might result in user confusion. Thus, a hysteresis of the results over time can be utilized to mitigate any confusion that might be caused by sudden changes to a marker (appearance of a marker, a marker suddenly disappearing). For example, a marker that is to be removed can be slowly faded from view (if the marker is in a viewing format). Alternatively or additionally, user focus can be a parameter that is taken into consideration when determining whether a marker that is being perceived by a user is relevant and/or whether the marker is not relevant (e.g., is not of interest to the user). Thus, if the user is looking at a maker (user focus is on the marker), the marker should not be removed from view or accidentally disappear due to an overly aggressive algorithm.

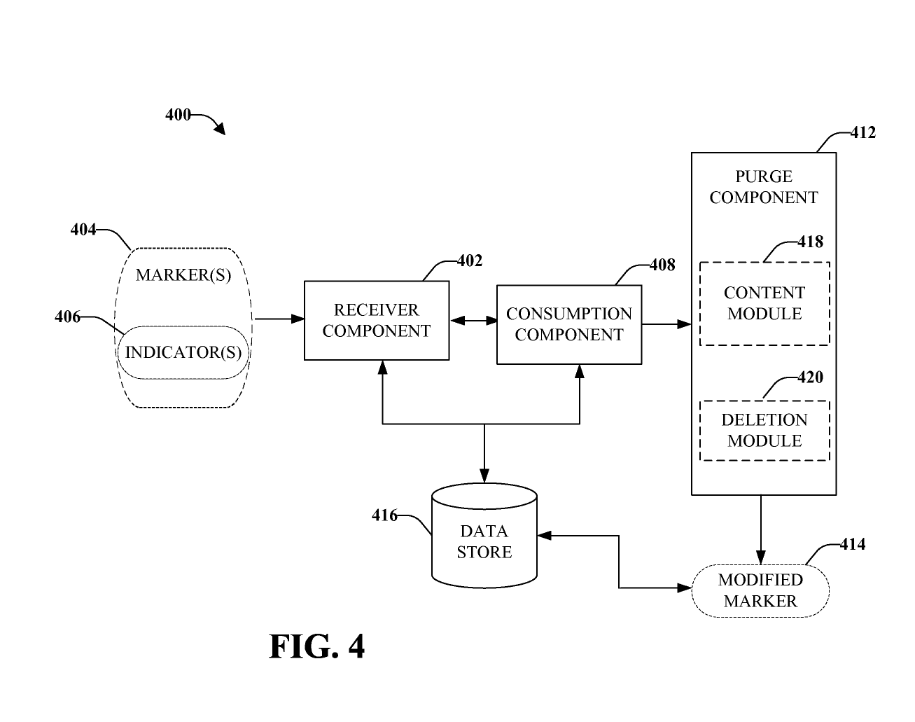

FIG. 4 illustrates a system 400 for changing one or more markers to a format that is of relevance to a requestor of that marker, according to an aspect. System 400 includes a receiver component 402 that is configured to receive one or more markers 404 and associated indicators 406. The indicators 406 can relate to one or more of: who provided the marker, why the marker was provided, when the marker was provided, where the marker was provided (or where in a mapping application the marker relates), what is the content of the marker (e.g., subject, information contained therein, and so on). A consumption component 408 is configured to receive a request for one or more markers and a purge component 412 selectively modifies the one or more markers 404 to create a new marker 414.

The consumption component 408 can retrieve the requested markers 404 from receiver component 402. Additionally or alternatively, the markers 404 (and associated indicators 406) can be retained in a data store 416. Further, the modified markers 414 can be retained in data store 416 and retrieved by system components 402, 408, 412. Data store 416 is intended to be a repository of all or portions of markers, sets of markers, or other information described herein and/or suitable for use with the disclosed aspects. Data store 416 can be centralized, either remotely or locally cached, or distributed, potentially across multiple devices and/or schemas. Furthermore, data store 416 can be embodied as substantially any type of memory, including but not limited to volatile or non-volatile, sequential access, structured access, or random access and so on. It should be understood that all or portions of data store 416 can be included in system 400 or can reside in part or entirely remotely from system 400.

Included in purge component 412 can be a content module 418 that is configured to evaluate one or more markers for general information, personalized information, or other information. The evaluation can be utilized for further analysis which can be related to the requestor to determine if it is appropriate to render a marker and/or in which format (e.g., visual, audio, and so forth) to render the marker.

Also included in purge component 412 can be a deletion module 420 that is configured to remove (permanently) one or more markers from data store 416. For example, if markers have an expiration data associated therewith, the marker can be automatically deleted upon expiration (or when it is discovered that the marker has expired). In accordance with some aspects, if information associated with a marker becomes obsolete, due to internal or external factors, the marker can be deleted. The internal or external factors can be evaluated based on the content of the marker as well as content received from other entities (e.g., markers associated with a restaurant are provided that indicate a new chef is working at the restaurant and, thus, markers related to a chef that is longer employed at the restaurant can be deleted). In accordance with some aspects, the marker and the modified marker are retained in data store 416 for response to a subsequent request. As such, the subsequent request can be responded to in a shorter amount of time since preprocessing has already been performed in the form of the modified marker. If desired, a user can selectively review an original marker and any subsequent markers.

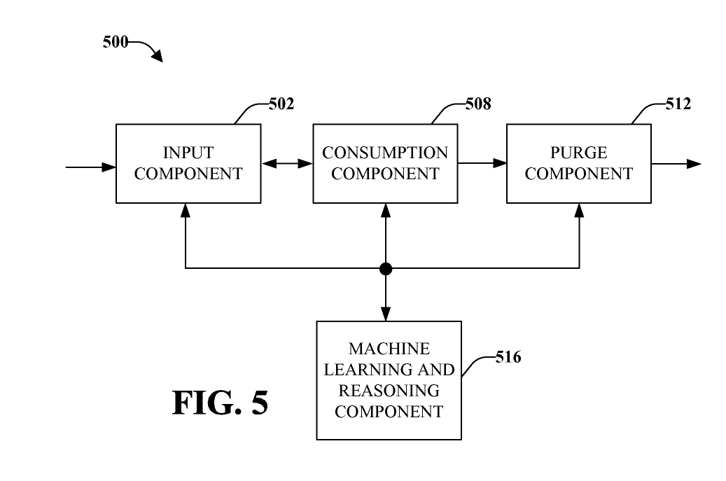

FIG. 5 illustrates a system 500 that employs machine learning and reasoning to automate one or more features in accordance with the disclosed aspects. System 500 includes an input component 502 that accepts one or more markers from different users. The one or more markers can be retained in a storage medium. Also included is a consumption component 508 that is configured to receive a request for at least a subset of the markers. Based on the request and other considerations (e.g., user preferences, user focus, user context, and so forth), a purge component 512 selectively modifies one or more markers and renders the modified markers in response to the request.

A machine learning and reasoning component 516 can employ various machine learning techniques to automatic one or more features of the disclosed aspects. The machine learning and reasoning component 516 can employ principles of probabilistic and decision theoretic inference and rely on predictive models constructed through the use of machine learning procedures. Logic-centric inference can also be employed separately or in conjunction with probabilistic methods. The machine learning and reasoning component 516 can monitor user activities to gather learning events, categorize these events by context, and apply these events to maintained models. Further, machine learning and reasoning component 516 can combine the output of these modules with source data (e.g., markers) to filter, promote, demote, aggregate, or expand the markers. Learning events include observing user behavior, monitoring user focus, and/or explicating receiving user inputs.

If the machine learning and reasoning component 516 has uncertainty related to whether the user is interested in a particular marker, the machine learning and reasoning component 516 can automatically engage in a short (or long) dialogue or interaction with the user (e.g., “What do you mean?”). In accordance with some aspects, machine learning component 516 engages in the dialogue with the user through another system component. Computations of the value of information can be employed to drive the asking of questions.

The various aspects (e.g., in connection with rendering markers, selectively modifying markers, and so forth) can employ various artificial intelligence-based schemes for carrying out various aspects thereof. For example, a process for determining if a particular marker should be presented (as opposed to another marker) can be enabled through an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer whether a user would be interested in a particular marker. In the case of markers, for example, attributes can be common markers, a combination of markers, content of markers, and the classes are applications or functions being utilized by the user.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more aspects can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to output a marker, which marker to output, what markers to group together, relationships between markers, and so forth. The criteria can include, but is not limited to, similar markers, similar requests, historical information, user focus, and so forth.

Additionally or alternatively, an implementation scheme (e.g., rule) can be applied to control and/or regulate markers, removing a marker from a set of markers, outputting a marker in a map application for consumption by a user, aggregating two or more markers, assigning a marker a higher (or lower) relevance value, and so forth. It will be appreciated that the rules-based implementation can automatically and/or dynamically modify a marker based upon a predefined criterion. In response thereto, the rule-based implementation can automatically interpret and carry out functions associated with that marker by employing a predefined and/or programmed rule(s) based upon any desired criteria.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

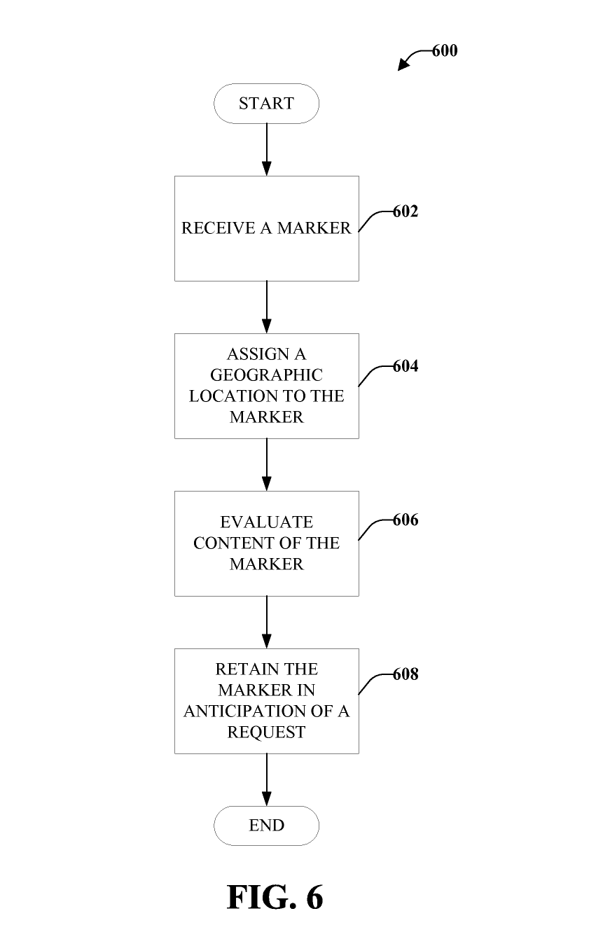

FIG. 6 illustrates a method 600 for receiving markers associated with a mapping application, according to an aspect. The markers can be general markers intended for consumption by others that are interested in a location and/or the markers can be personalized markers intended for a specific individual or a subset of people.

At 602, a marker is received. Markers can be received from a multitude of users at substantially the same time or at different times. Additionally, the markers can be related to different geographic locations. Further, markers can include indicators that relate to information that the provider wants to share related to a location (e.g., place, object, and so forth). In accordance with some aspects, markers can be automatically generated based on user activities.

A geographic location is assigned to each marker, at 604. The geographic location is assigned to facilitate rendering of the marker when various criteria related to the geographic location is satisfied by the user that provided the marker and/or a different user. The geographic location can be assigned based on a nearness (e.g., does not have to be an exact location but an approximate location).

At 606, content of the marker is evaluated for various indicators. The indicators can include one or more of who provided the marker, when the marker was provided, a location associated with the marker, why the marker was provided, and/or what the marker relates to.

The various markers can be retained in storage media, at 608, in anticipation of a request to receive the marker is received at a later time. The request to receive the marker can be from the user that provided the marker or from a different user. In accordance with some aspects, a determination to output one or more markers is performed automatically based on a user context, a user location, or other criteria (e.g., a marker in the form of an advertisement is presented to a user based on a user focus or a direction in which a user is facing).

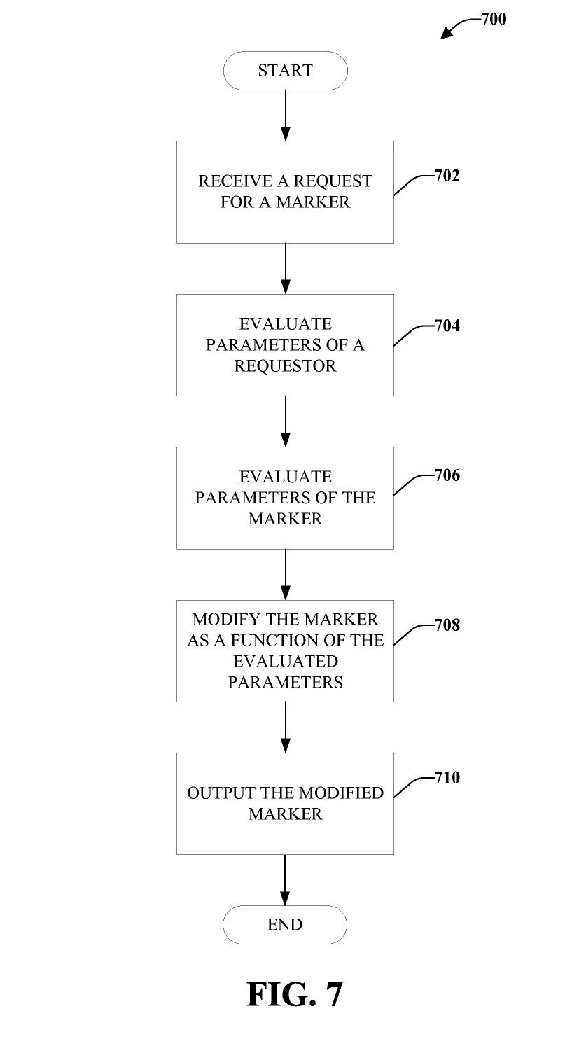

FIG. 7 illustrates a method 700 for selectively rendering markers based upon a request in accordance with an aspect. At 702, a request for a marker is received. This request can be an automatic request that is generated when criteria related to a geographic location is satisfied (e.g., a user is physically at a location, a user is virtually visiting a location, and so on). In accordance with some aspects, the request can be a manual request. For example, a user might be interested in learning information about a place and requests markers associated with that place.

At 704, parameters of the requestor are evaluated. These parameters can include preferences of the requestor, historical information about the requestor, an association between the requestor and the provider of the marker, rules, policies, and so on. In accordance with some aspects, the focus of the requestor is evaluated (e.g., is the user focused on a particular marker, which direction is the user facing, and so forth). Additionally or alternatively, parameters of the requested marker (or markers) are evaluated, at 706. This evaluation can include reviewing the content of the marker for obsolete data, redundant data (e.g., two or more markers associated with a location contain similar content, and so forth).

At 708, the one or more markers are modified as a function of the evaluated parameters. An evaluated parameter can be an association between the person that provided the marker and the person that is to receive the marker. Each marker can be ranked (based on a sliding scale of relevancy) on how close the relationship is between the two people. In accordance with some aspects, the modification or relevance of the marker can be whether the marker is complete noise (e.g., the person is not interested in receiving the marker versus a person that is very interested in the marker). Further, a ranking or priority level can be assigned to each marker, a higher priority level can be assigned to markers with a higher level of preference, for example. According to some aspects, the marker is modified based on the provider and how interested the requestor would be to receive other markers from that provider.

In accordance with some aspects, user activities are monitored to gather learning events, which can be evaluated by context, and the learning events are applied to one or more models. The learning events can include explicit feedback from the user, observing user requests and the response of the user to request responses, and/or user focus. Outputs of the one or more models are conflated with source data, such as markers, to promote, demote, expand, aggregate, and/or filter the markers.

The modified markers are output, at 710, in any perceivable format (e.g., visual, audio, tactile, and so forth). In accordance with some aspects, the marker is depersonalized such that the person perceiving the marker does not know who left the marker. In accordance with some aspects, the rendered markers can be markers of people having the same demographics and experiences as the requestor. According to some aspects, the marker is an advertisement that is tailored for the person that will receive the marker. According to other aspects, the markers can be based on a dating service or other service that is intended to bring people with similar interests together.

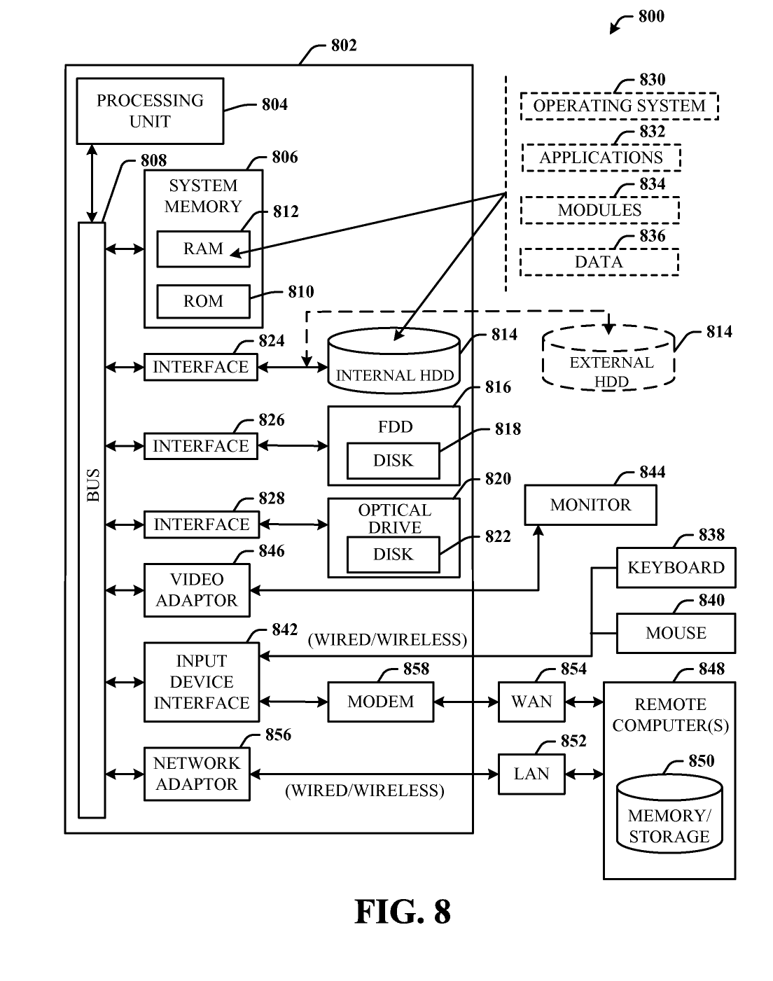

Referring now to FIG. 8, there is illustrated a block diagram of a computer operable to execute the disclosed architecture. In order to provide additional context for various aspects disclosed herein, FIG. 8 and the following discussion are intended to provide a brief, general description of a suitable computing environment 800 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the various aspects can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 through an interface, such as a video adapter 846. In addition to the monitor 844, a computer typically includes other peripheral output devices (not shown), such as speakers, printers, etc.

The computer 802 may operate in a networked environment using logical connections through wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 through the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Memory 806 can be communicatively coupled to processing unit 804 and can have stored therein computer-executable instructions configured to implement a system that manages markers as a function of a relevancy of the markers. The system can include an input component that receives a marker and at least one indicator associated with the marker. The received marker can be a copy of an original marker, which was previously modified. Alternatively or additionally, the marker can be a personal marker or a generic marker that corresponds to a geographic location. A plurality of markers can be associated with a single location. In accordance with some aspects, the marker is an advertisement that is automatically presented when a user location matches a location of the advertisement. The indicator associated with the marker includes at least one of a user identity, a time stamp, a location, a reason the marker was provided, what the marker relates to, or combinations thereof.

System also includes a consumption component that receives a request for the marker and the indicator. In accordance with some aspects, consumption component evaluates parameters of a requestor to determine a relevancy of the marker to the requestor. Also included in system can be a purge component that automatically modifies the marker as a function of the indicator and a requestor, the purge component outputs the modified marker. The purge component can automatically modify the marker based on an association between the requestor and a provider of the marker. The marker and the modified marker can be retained in a memory for response to a subsequent request.

System can also include a deletion module that selectively removes at least one of the plurality of markers based on similar content. Further, deletion component can evaluate an expiration associated with the marker and remove the marker upon detection of expiration of the marker. In accordance with some aspects, deletion component removes the marker based on external factors (e.g., one or more parameters associated with the marker content have changed).

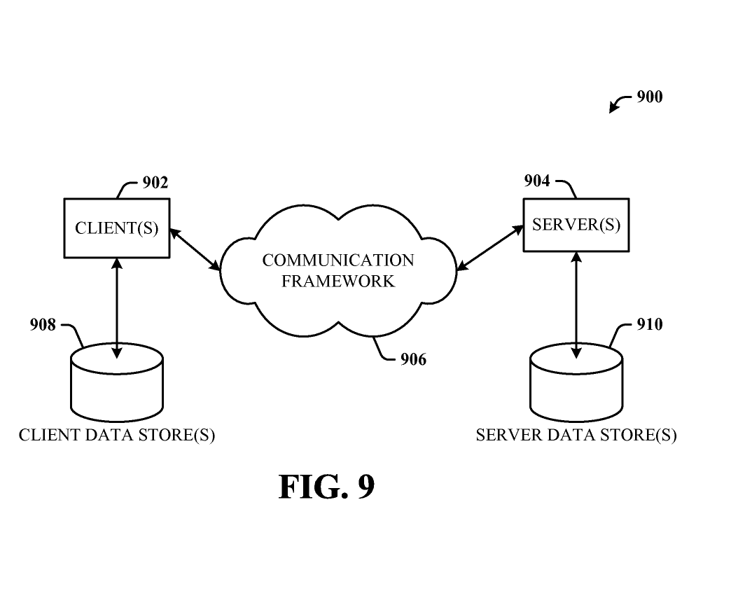

Referring now to FIG. 9, there is illustrated a schematic block diagram of an exemplary computing environment 900 in accordance with the various aspects. The system 900 includes one or more client(s) 902. The client(s) 902 can be hardware and/or software (e.g., threads, processes, computing devices). The client(s) 902 can house cookie(s) and/or associated contextual information by employing the various aspects, for example.

The system 900 also includes one or more server(s) 904. The server(s) 904 can also be hardware and/or software (e.g., threads, processes, computing devices). The servers 904 can house threads to perform transformations by employing the various aspects, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated through a wired (including optical fiber) and/or wireless technology (including non-radio wireless communications). The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.”

The term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that manages markers as a function of a relevancy of the markers, comprising:
an input component that receives a marker and at least one indicator associated with the marker;
a consumption component that receives a request for the marker and the indicator; and
a purge component that automatically modifies the marker as a function of the indicator and the request the purge component outputs the modified marker, wherein the indicator associated with the marker includes a user identity, a time stamp, a location, a reason, what the marker relates to, or combinations thereof.

2. The system of claim 1, the marker is a personal marker or a generic marker and corresponds to a geographic location.

3. The system of claim 1, the consumption component evaluates parameters of the request to determine a relevancy of the marker.

4. The system of claim 1, the received marker is a copy of an original marker.

5. The system of claim 1, the marker and the modified marker are retained in a data store for response to a subsequent request.

6. The system of claim 1, the purge component automatically modifies the marker based on an association between a requestor and a provider of the marker.

7. The system of claim 1, wherein a plurality of markers are associated with a single location, the system further comprising a deletion module that selectively removes at least a portion of one of the plurality of markers based on similar content.

8. The system of claim 1, further comprising a deletion component that evaluates an expiration associated with the marker and removes the marker upon expiration.

9. The system of claim 1, further comprising a deletion component that removes at least a subset of the marker based on external factors.

10. The system of claim 1, the marker is an advertisement that is automatically presented when a user location matches a location of the advertisement.

11. A method for proving a relevant marker within a mapping application, comprising:
receiving one or more markers associated with a geographic location, the marker comprises at least one indicator;
accepting a request for information associated with the geographic location;
retrieving at least one marker related to the geographic location,
evaluating relevancy of the at least one indicator to the requestor;
modifying the at least one marker as a function of the relevancy; and
presenting the modified marker in response to the request.

12. The method of claim 11, the at least one indicator relates to when the marker was provided, who provided the marker, why the marker was provided, what the marker relates to, where the marker can be found in a mapping application, or combinations thereof.

13. The method of claim 11, further comprising:
determining an association between a requestor and a provider of at least one marker; and
modifying a portion of the at least one marker as a function of the association.

14. The method of claim 11, further comprising:
retaining the received marker in a data store; and
copying at least one marker related to the geographic location before retrieving the at least one marker.

15. The method of claim 11, further comprising:
determining at least two markers are associated with a single location; and
deleting at least one of the two markers if the markers contain similar indicators.

16. The method of claim 11, further comprises disregarding a marker if it is not relevant to the requestor.

17. The method of claim 11, the marker is an advertisement that is automatically presented when a user location matches a location of the advertisement.

18. A computer-readable medium having stored thereon the following computer executable components:
a receiver component that accepts one or more markers associated with a geographic location, the marker comprises at least one indicator that relates to when the marker was provided, who provided the marker, why the marker was provided, what the marker relates to, where the marker can be found in a mapping application, or combinations thereof, the marker and indicator are retained in a storage media;
a consumption component that receives a request for information associated with the geographic location and retrieves a copy of the maker and indicator from the storage media;
a purge component that evaluates relevancy of the at least one indicator to the requestor and modifies a portion of the at least one marker as a function of the relevancy, the relevancy includes an association between the requestor and a provider of at least one marker; and
a user interface that outputs the modified marker in a mapping application in response to the request.

19. The computer-readable medium of claim 18, the storage media copies the least one marker related to the geographic location before retrieval of the at least one marker.

20. The computer-readable medium of claim 18, the marker is an advertisement that is automatically presented when a user location matches a location of the advertisement.
